(19) United States
(12) Patent Application Publication
(10) Pub. No.: US 2014/0243589 A1
(43) Pub. Date: Aug. 28, 2014

(54) Disposable Vibratory Apparatus

(71) Applicant: Kinkel Rowan, San Francisco, CA (US)

(72) Inventor: Kinkel Rowan, San Francisco, CA (US)

(21) Appl. No.: 14/180,246

(22) Filed: Feb. 13, 2014

Related U.S. Application Data
(60) Provisional application No. 61/769,583, filed on Feb. 26, 2013.

(51) Int. Cl. A61H 23/02; A61H 19/00

(52) U.S. Cl. CPC A61H 23/02; A61H 19/30
USPC 600/38; 601/46

(57) ABSTRACT

A disposable vibratory apparatus includes a patch enclosing a battery and a vibratory element with a removable nonconductive tab for turning the apparatus on or off. The apparatus may be applied to a target area of the human body via an adhesive layer to provide vibratory sensation for therapeutic or pleasurable purposes. The vibratory apparatus configuration comprises minimal components within the patch providing portability and freedom of movement without an external controller or power source.

The invention relates to vibratory devices. In particular, the invention relates to vibratory devices used for application to living animals, including humans.

### RELATED ART

Vibrators are devices used to generate tactile feedback or stimulation through mechanical vibratory motion. Consumer products such as mobile phones and portable electronic media players employ vibrators to produce tactile feedback or to notify users about specific events or functions. Another class of devices uses vibratory motion to induce a therapeutic or pleasurable effect for the user. Such devices include applications for massage, relaxing sore muscles, providing other beneficial sensations, and treating human muscle pain.

Typically, therapeutic vibratory devices externally apply vibration and, in some cases, heat to a skin area to produce the beneficial effect. Such devices typically take the form of a patch or pad applied directly to the skin and powered by a cord that plugs into a wall outlet. Other devices require a 9-volt or other large external battery to provide the necessary electrical power to the vibratory element. A form of gel is commonly used to adhere to the skin and transfer the vibration and heat to the user from the other elements.

In devices where a power cord is required, range of use is limited to locations with access to a nearby electrical outlet. Additionally, consumers may be inconvenienced by having a linked power cord attached to the device. For example, it may be uncomfortable for a user to apply a vibrating patch with a linked power cord while sleeping or in bed. The user may be concerned about becoming tangled in the cord or unplugging the device if the user should roll over or move away from the power outlet. Other devices that employ a large battery are inconvenient for users who must conserve space while traveling or on the move. Battery packs are bulky and have additional connections which may become detached from the device if the user is moving. Furthermore, additional weight from a battery and battery enclosure may become burdensome or cumbersome if worn for extended periods, depending on where the device is placed on the body. If the user intends to use such a device for sexual pleasure or stimulation, either alone or with one or more partners, such problems are exacerbated, as freedom of motion without affecting the performance of the device, even during vigorous movement, is critical. In such cases, having an external cord or a separate battery pack can significantly impair the function of the device by limiting movement and/or adding additional bulk.

Consequently, there exists a substantial unmet need for a vibratory patch that is internally powered, minimizing components and bulk. Minimizing components allows the device to be manufactured as a disposable use product that can be easily replaced. There is a need for such a device, once applied to the body, to allow the user to move freely with no other devices required to produce power for the vibratory element.

### BRIEF SUMMARY OF THE INVENTION

In view of the foregoing described needs, an embodiment of the present invention includes a vibratory apparatus comprised of a vibratory element and a battery enclosed in a patch. The battery is connected to the vibratory element by two conductors to allow operation. A nonconductive tab is inserted between the conductors and the vibratory element prior to use. The patch may be applied to a target surface area of the human body to provide therapeutic or pleasurable vibratory sensation. The apparatus includes an adhesive on one surface for application to the target surface area. A protective layer covers the adhesive to maintain its stickiness and avoid contamination. The nonconductive tab is connected to the protective layer. Removal of the protective layer simultaneously pulls and removes the nonconductive tab, thereby allowing the battery to transmit power to the vibratory element for use.

### BRIEF DESCRIPTION OF THE DRAWINGS

For a more complete understanding of the present invention, reference is made to the detailed description contained herein and the accompanying drawings numbered below which are given by way of illustration only and are not intended to be limitative to any extent. Commonly used reference numbers identify the same or equivalent parts of the claimed invention throughout the several figures. Now, therefore:

FIG. 1 is a top view depicting a vibratory apparatus in accordance with an exemplary embodiment of the present invention;

FIG. 2 is a side view depicting the vibratory apparatus of FIG. 1; and

FIG. 3A is a side view depicting the vibratory apparatus controlled by a removable interposing nonconductive tab in accordance with an exemplary embodiment of the present invention;

FIG. 3B is a side view depicting the vibratory apparatus with adhesive and protective film in accordance with an exemplary embodiment of the present invention;

FIG. 3C is a side view depicting the vibratory apparatus in packaging in accordance with an exemplary embodiment of the present invention; and

FIG. 4 illustrates an exemplary embodiment of the present invention depicting placement on the shoulder of a human user.

### DETAILED DESCRIPTION

The following description is merely exemplary in nature and is in no way intended to limit the invention, its application, or its uses. Following is a description of an exemplary embodiment of a disposable vibratory apparatus according to the invention.

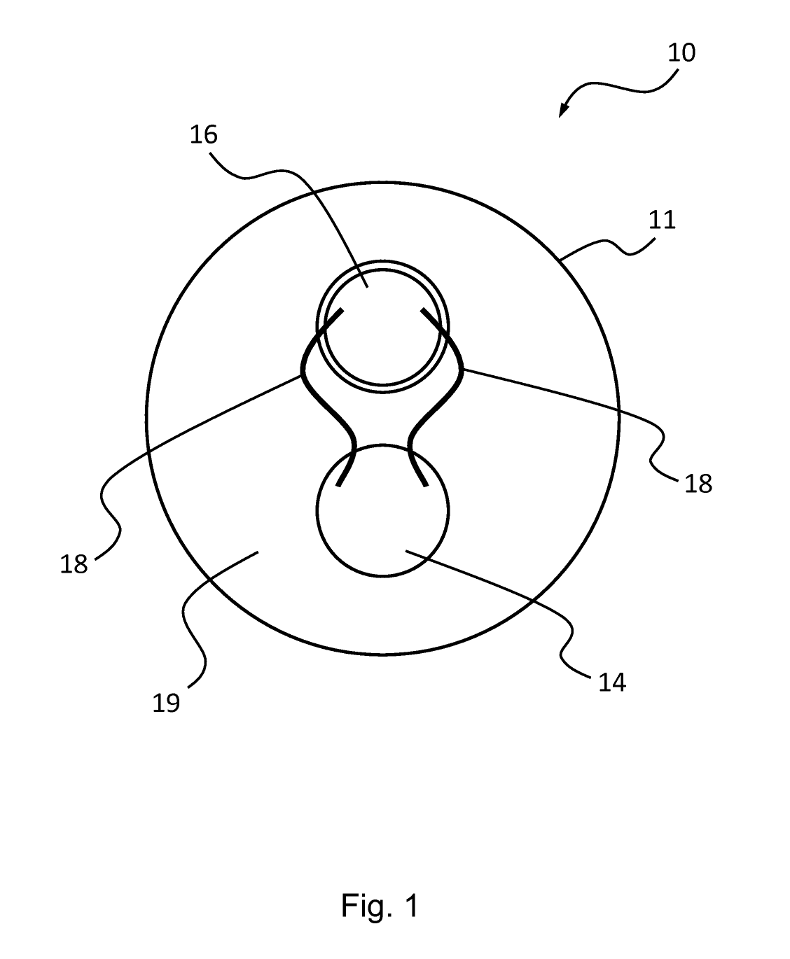

As illustrated in FIG. 1, a disposable vibratory apparatus 10 is used to provide vibratory sensation when activated. The minimal components and small size support a disposable application of the apparatus 10, if desired. According to an exemplary embodiment of the present invention, the vibratory apparatus 10 comprises a patch 11 for attachment to the skin surface of a human or other living animal. The patch 11 houses and encloses a vibratory element 14 and a battery 16. The battery 16 provides electrical power to activate the vibratory element 14 by two conductors 18 connecting terminals of the battery 16 to the vibratory element 14.

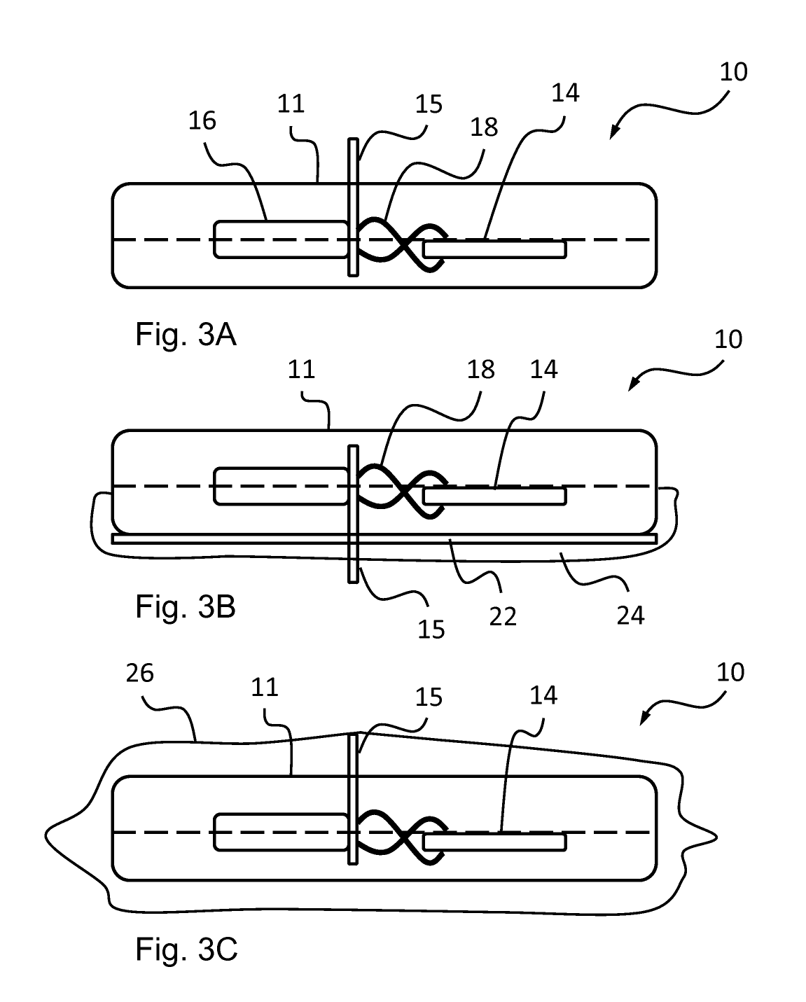

Conductors 18 are shown in FIG. 1 as comprising two wires; however, the conductors 18 can comprise other conductive means, such as direct conductive contact between terminals of the battery 16 and contacts on the vibratory element 14. In an alternative embodiment, the vibratory element 14 and the battery 16 lie adjacent and are directly connected. In a further embodiment, as shown in FIGS. 3A-3C, a nonconductive tab 15 resides between the conductive means and contacts on the vibratory element 14 to prevent operation of the vibratory element 14 prior to actual use. The nonconductive tab 15 is removed to allow conductive contact between the conductive means associated with the battery 16 and the vibratory element 14. Where a coin cell battery is used to power the vibratory element 14, the coin cell battery can be housed in a holder that includes a switching mechanism for turning the apparatus 10 on or off. These holders are readily available in different configurations applicable to use in the apparatus 10.

In the present exemplary embodiment, in FIG. 1, the patch 11 is shown as having a circular shape, though other shape configurations may be used to alter the vibratory sensation or to fit various body areas and skin surfaces. In addition, the shape of the patch 11 may be changed to provide pleasing shapes of interest to the user, such as, circular, oval, square, rectangular, heart-shaped, diamond-shaped, triangular, smiley face, or other desirable shapes. The ability to change the shape of the patch 11 also allows the apparatus 10 to be adapted to and conform to various areas of the body to ensure snug application. Additionally, the shape of the patch 11 can be configured to fit within clothing of a user to avoid the need for adhesive attachment to the skin of the user. For example, the patch 11 can be formed in a triangular shape to conform to a female user's pubic area and fit snugly within the user's undergarments for concealment. In addition, the patch 11 accommodates customization and printing of various designs on the surfaces of the patch 11.

In an alternative embodiment, the vibratory element 14, battery 16, and conductive wires 18 may be held together by an internal silicone or other malleable encasing or housing in order to provide stability and isolation from the material of the patch 11. In addition, the amount of vibration delivered to the skin surface may be adjusted by changing the attenuative properties of the material of the patch 11.

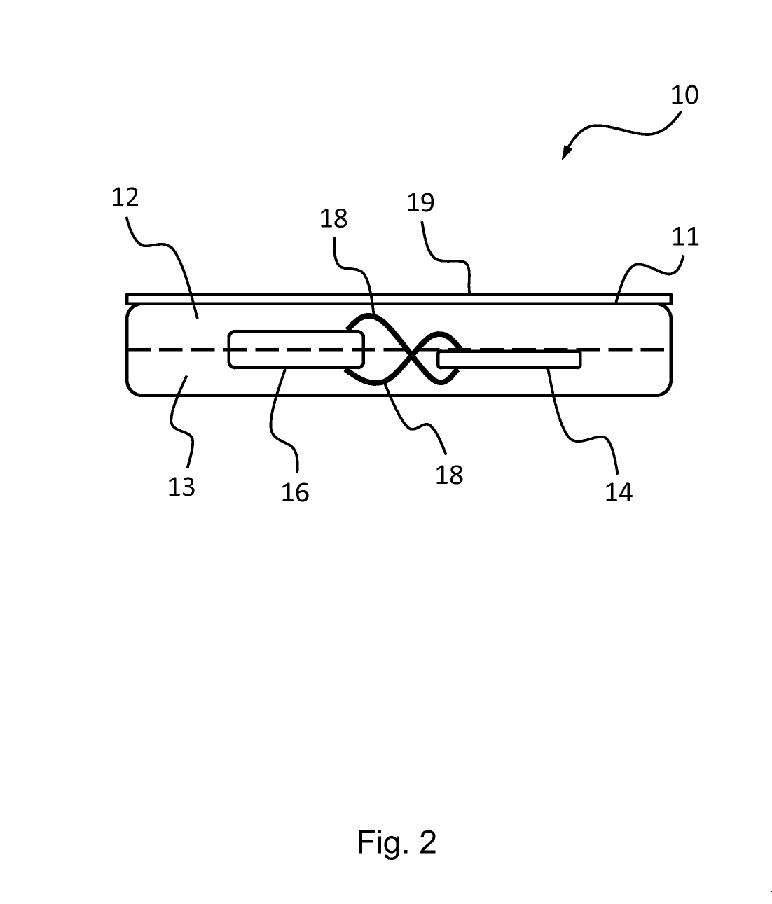

Now, referring to FIG. 2, an exemplary embodiment of the apparatus 10 is described in greater detail. A patch 11 comprises two layers: a top layer 12 and a bottom layer 13. A vibratory element 14, battery 16, and conductive wires 18 are housed between the two layers 12, 13. In this embodiment, the patch 11 is shown as having a rectangular profile, though other profile configurations may be used to give different vibratory sensations or to fit various body areas and skin surfaces. The outside surface of the patch 11 is covered by a protective layer 19, which may be composed of a film or breathable membrane. The protective layer 19 serves as a barrier to prevent the patch 11 from adhering to clothing or other external objects.

Now, referring to FIGS. 3A-3C, other exemplary embodiments of the apparatus 10 are described in greater detail. In another exemplary embodiment, as shown in FIG. 3A, the vibratory element 14 is controlled by interposing a nonconductive tab 15 between its electrical terminals and conductors 18 from the battery 16. The nonconductive tab 15 is movable between a first position in which the tab separates the terminals from the conductors 18 and a second position in which the tab is removed from the terminals to bring the terminals in contact with the conductors 18 to activate the vibratory element 14. In this exemplary configuration, the tab 15 extends to the outside of the patch 11, allowing the user access to completely remove the tab 15 which will cause the apparatus 10 to operate until the battery 16 has been depleted. Additionally, in another embodiment, illustrated in FIG. 3B, where adhesive 22 may be used to more firmly attach the patch 11 to the user's skin, the nonconductive tab 15 is attached to a protective film 24 applied over the adhesive. Removal of the protective film 24 likewise removes the tab 15 to activate the vibratory element 14. In another embodiment, shown in FIG. 3C, where the patch 11 is sealed in packaging 26, such as a cellophane enclosure, the nonconductive tab 15 is attached to the packaging 26. When the packaging 26 is opened and the patch 11 is removed from the enclosure, the nonconductive tab 15 is likewise removed and the vibratory element 14 is activated. Alternatively, the vibratory element 14 includes an integral switch configured to be depressed to activate and deactivate the vibratory element 14. The switch may be housed internally within the patch 11, in which case a user may activate the apparatus 10 by squeezing or depressing the patch 11 so as to trigger the switch. Alternately, the switch may be accessible at a location on the surface of the apparatus 10. In another alternative embodiment, the battery 16 may be controlled by an electronic switch accessible wirelessly to provide remote control of the apparatus 10.

The vibratory and therapeutic properties of the vibratory apparatus 10 can be varied by adapting the vibratory element 14, the battery 16, or the material comprising the top layer 12 or bottom layer 13. Typically, the battery 16 is of the type known as either a button cell or a coin cell battery. A button cell is a small single cell battery shaped as a squat cylinder, typically 5 to 20 mm in diameter and 1 to 6 mm high, similar in size and shape to a button on a garment. Alternatively, the battery 16 may also be a coin cell battery in the shape and size of a coin; for example, a nickel, quarter or dime. The coin cell configuration will include a holder for the coin cell battery where the holder may include an integral on/off switch.

In one exemplary embodiment, the vibratory apparatus 10 uses a battery 16 of the button cell type to ensure a long shelf life of the apparatus 10 due to the low self-discharge rate of the button cell type battery. Where higher power and capacity is desired for support of the selected vibratory element 14, the battery 16 may be comprised of a zinc-air cell. The zinc-air cell will cause the battery 16 of the vibratory apparatus 10 to have a substantially shortened shelf life and hence, should be used within a few weeks from production and assembly of the apparatus 10.

The battery 16 of the button cell type is a single-celled battery, usually a disposable primary cell. Common anode materials for the button cell are zinc or lithium. Common cathode materials are manganese dioxide, silver oxide, carbon monofluoride, cupric oxide or oxygen from the air. Since disposability is a feature of the vibratory apparatus 10, the battery 16 does not contain any material that might be toxic such as mercuric oxide, wherein the mercury is toxic and an environmental hazard. In the case where the battery 16 is a button cell, the button cell includes a metal can forming the bottom body, with a circular insulated top cap. The can is the positive terminal and the top cap the negative terminal.

Button cells of different chemical composition made in the same size are mechanically interchangeable. However, the composition can affect service life and voltage stability relative to driving the vibratory element 14 of the apparatus 10. Wherein the battery 16 is required to be of the same type and size, the specified capacity in milliampere-hours (mAh) is optimized for different loads by using different electrolytes, so that one may have longer service life than another battery using a different electrolyte when supplying a relatively high current. For example, the battery 16 may comprise a silver cell having very stable output voltage until it suddenly drops very rapidly at the end of its life. The battery 16 may alternatively consist of an alkaline battery but will typically provide less capacity and less stable voltage but drops more gradually during use as compared to more costly silver oxide or lithium cells. The operational parameters of the apparatus 10 can be adjusted for differing therapeutic or sensational benefits and outcomes.

In another exemplary embodiment, the battery 16 of the vibratory apparatus 10 consists of a zinc-air battery wherein air serves as the depolarizer. The zinc-air battery has a higher capacity than other types since the air does not need to be supplied in the battery. Additionally, activation of a zinc-air battery can be triggered by removing a seal to allow air to enter the cell.

Although shown as comprising a top layer 12 and a bottom layer 13, in an alternative embodiment, the patch 11 can be produced of a single molded piece wherein the patch 11 is formed around the vibratory element 14 and the battery 16. The material comprising the layers 12, 13 may be any of a gel, silicone, neoprene, cloth, polymer, rubber, plastic, paper or other similar material that can be adapted to house the components of the apparatus 10. Attachment of the patch 11 to the skin of a user is enabled via an appropriate adhesive, for example, a hypoallergenic/non-allergenic adhesive, such as that used to adhere adhesive bandages. Further, the material comprising the layers 12, 13 may be comprised of an antibacterial material to minimize risk of infection during use. Still further, the material may incorporate additional substances and chemicals to generate a scent which is noticeable to a user during use of the apparatus.

Additionally, wherein the vibratory apparatus 10 uses a battery 16 reliant on zinc-air chemical composition, the top layer 12 or bottom layer 13 includes a perforated portion adjacent the area of the battery 16 that needs to be exposed to the air. Consequently, the apparatus 10 includes a sealing tab over the perforated portion that is removed for use. In an alternate embodiment, the zinc-air battery may be enclosed in a vacuum-sealed pouch such that the battery is not activated until the pouch seal is broken by the user.

In another exemplary embodiment, the vibratory apparatus 10 can include a vibratory element 14 having differing vibrating frequencies for selection by a user. Still further, the vibratory apparatus 10 can likewise include different types of batteries 16 to support the production of a more energetic vibration, a longer duration use, or any combination thereof to suit a user's preference.

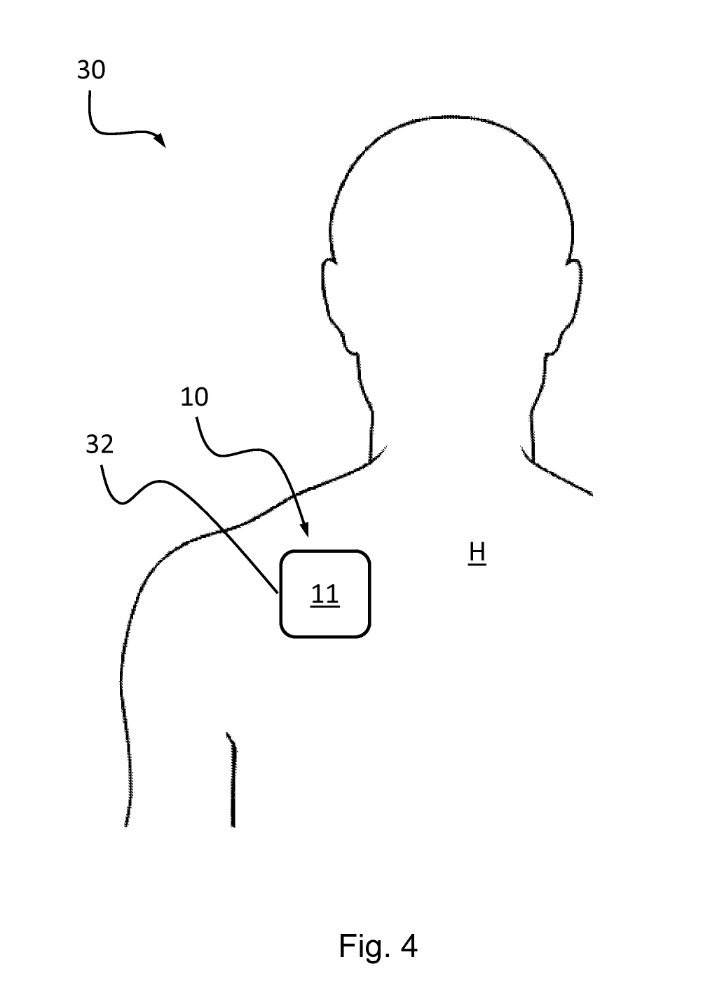

Now, referring to FIG. 4, an exemplary embodiment of the present invention in application 30 to a target area 32 of a human H is described. The vibratory gel apparatus 10 is attached to the skin at the target area 32; for example, a shoulder as depicted in FIG. 4. The attachment is accomplished by the bonding properties of the patch 11 against the skin or, in an alternative embodiment, an adhesive may be applied to the area of the patch 11 to be attached to the skin to provide greater bond strength. Where an adhesive is used, a protective film 24 is provided to maintain the stickiness of the adhesive prior to use. When the vibratory apparatus 10 is activated, the patch 11 transmits the mechanical vibration energy produced by the vibratory element 14 to the target area 32.

In use, an individual would apply the vibratory apparatus 10 to the user's skin at a target area 32. Once the individual user has received sufficient vibratory treatment or sensory stimulation from the vibratory gel apparatus 10, the user would then discard the vibratory apparatus 10. The vibratory apparatus 10 would not require disposal in a particular battery disposal system since the battery 16 used in the vibratory apparatus 10 is neither toxic nor hazardous.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

I claim:

1. A disposable vibratory apparatus suitable to deliver vibration to specified areas on a body, the vibratory apparatus comprising:
(a) a patch having a top layer and a bottom layer;
(b) a vibratory element housed within the patch between the top layer and the bottom layer;
(d) a battery housed within the patch between the top layer and the bottom layer; and
(e) means for conductively connecting the battery to the vibratory element to initiate vibratory stimulation.

2. The apparatus of claim 1 wherein the top layer and bottom layer are made from any of a gel, silicone, neoprene, paper, cloth, rubber, and plastic.

3. The apparatus of claim 1 wherein the patch has a shape to conform to a specific body area.

4. The apparatus of claim 3 wherein the shape is any of heart, circular, oval, square, rectangular, diamond, and triangular.

5. The apparatus of claim 1 wherein internal components are encased within a separate housing.

6. The apparatus of claim 1 wherein outside surfaces of the patch are covered by a protective layer.

7. The apparatus of claim 1 wherein means for conductively connecting the battery to the vibratory element to activate the apparatus comprises a switch associated with a battery holder.

8. The apparatus of claim 1 wherein means for conductively connecting the battery to the vibratory element to activate the apparatus comprises removal of a nonconductive tab.

9. The apparatus of claim 1 wherein means for conductively connecting comprises depression of an internal switch.

10. The apparatus of claim 1 wherein the amount of vibration delivered to the skin surface is adjusted by changing attenuative properties of the material of the layers.

11. The apparatus of claim 1 wherein either of the top layer or bottom layer includes a perforated portion to allow exposure of the battery to air.

12. The apparatus of claim 8 wherein the battery is a zinc-air battery and the battery is activated by removal of a seal from the perforated portion to allow air to enter the cell of the battery.

13. The apparatus of claim 1 wherein the battery is selected to provide any of a more energetic vibration, a longer duration of use, or combination thereof.

14. The apparatus of claim 1 wherein components of the apparatus are made from nontoxic, disposable materials and the apparatus is disposable.

15. The apparatus of claim 1 wherein the vibratory element is operable at differing vibrating frequencies selectable by the user.

16. A portable vibratory apparatus for external use in producing sexual stimulation comprising:
(a) a patch having a top layer and a bottom layer;
(b) a vibratory element housed within the patch between the top layer and the bottom layer;
(d) a battery housed within the patch between the top layer and the bottom layer to power the vibratory element; and
(e) means for conductively connecting the battery to the vibratory element to activate the vibratory element to produce vibratory stimulation through the apparatus.

17. The apparatus of claim 16 wherein the apparatus is sized to conform to a target body area to allow a user to move freely during use of the apparatus.

18. The apparatus of claim 16 wherein the material of the top layer and bottom layer includes anti-bacterial properties.

19. A portable and disposable vibratory apparatus for creating stimulation on parts of the body wherein the vibratory apparatus is applied, the apparatus comprising:
(a) a disposable vibratory element;
(b) a disposable battery for powering the vibratory element;
(c) a disposable housing comprised of a conformable material for adaption to body parts and enclosure of the vibratory element and the battery;
(d) a nonconductive tab for separating the battery from the vibratory element,
(e) an enclosure for storing the apparatus prior to use;
(f) the nonconductive tab attached to the enclosure wherein removal of the apparatus from the enclosure causes the nonconductive tab to be removed from between the battery and the vibratory element, thereby causing the apparatus to be activated for use.

20. The apparatus of claim 17 wherein the housing includes scented material.
